(19) United States
(12) Patent Application Publication
(10) Pub. No.: US 2010/0302000 A1
(43) Pub. Date: Dec. 2, 2010

(54) BIOMETRIC IDENTIFY VERIFICATION INCLUDING STRESS STATE EVALUATION

(75) Inventors: Andrea Szymkowiak, Dundee (GB); Michael Charles Dowman, Dundee (GB); Leslie Derek Ball, Dundee (GB)

Correspondence Address: BERKELEY LAW & TECHNOLOGY GROUP, LLP, 17933 NW Evergreen Parkway, Suite 250, BEAVERTON, OR, 97006, US

(73) Assignee: University of Abertay Dundee, Dundee (GB)

(21) Appl. No.: 12/555,429

(22) Filed: Sep. 8, 2009

(30) Foreign Application Priority Data
May 27, 2009 (GB) GB0909110.9

(51) Int. Cl. G05B 19/00

(52) U.S. Cl. 340/5.82

(57) ABSTRACT

Subject matter disclosed herein may relate to a biometric security technique, and may relate to biometric identity verification and emotional stress state evaluation.

This application claims priority from UK Patent Application No. GB0909110.9, filed May 27, 2009, and entitled “A Biometric Security Method, System and Computer Program.”

### FIELD

Subject matter disclosed herein may relate to a biometric security technique, and more particularly may relate to biometric identity verification and emotional stress state evaluation.

### BACKGROUND

In today's increasingly digital world, automatic identity verification systems are finding growing application in a variety of areas, such as controlling access to secure facilities or authorizing remote financial transactions, for example. Indeed, recent growth of web-based services such as online banking further emphasizes the need for reliable automatic mechanisms of identity verification.

### BRIEF DESCRIPTION OF THE FIGURES

Claimed subject matter is particularly pointed out and distinctly claimed in the concluding portion of the specification. However, both as to organization and/or method of operation, together with objects, features, and/or advantages thereof, it may best be understood by reference to the following detailed description when read with the accompanying drawings.

FIG. 1 is a flowchart depicting an example offline processing phase of an example embodiment of a biometric security technique.

FIG. 2 is a flowchart depicting an example online processing phase of an example embodiment of a biometric security technique.

FIG. 3 is a diagram illustrating an example three-dimensional distribution of signatures acquired from a plurality of users.

FIG. 4 is a schematic block diagram illustrating an example embodiment of a biometric security system.

FIG. 5 is a graph depicting an example comparison of a length of time between a release and depression of successive keystrokes from two example users.

FIG. 6 is a graph depicting an example comparison of a length of time a given key is held down by two example users.

FIG. 7 is a graph depicting an example comparison of a length of time between a release and depression of successive keystrokes of an example user in a normal and in a stressed condition.

FIG. 8 is a graph depicting an example comparison of a length of time a given key is held down by an example user in a normal and in a stressed condition.

Reference is made in the following detailed description to the accompanying drawings, which form a part hereof, wherein like numerals may designate like parts throughout to indicate corresponding or analogous elements. It will be appreciated that for simplicity and/or clarity of illustration, elements illustrated in the figures have not necessarily been drawn to scale. For example, the dimensions of some of the elements may be exaggerated relative to other elements for clarity. Further, it is to be understood that other embodiments may be utilized and structural and/or logical changes may be made without departing from the scope of claimed subject matter. It should also be noted that directions and references, for example, up, down, top, bottom, and so on, may be used to facilitate the discussion of the drawings and are not intended to restrict the application of claimed subject matter. Therefore, the following detailed description is not to be taken in a limiting sense and the scope of claimed subject matter defined by appended claims and their equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as to not obscure claimed subject matter.

As discussed above, automatic identity verification systems are finding growing application in a variety of areas, and recent growth of web-based services further emphasizes the need for reliable automatic mechanisms of identity verification. Example applications for automatic identity verification systems may include, but are not limited to, controlling access to secure facilities and authorizing remote financial transactions, to name but a couple of examples.

Traditional automatic identity verification systems rely on passwords or tokens. As utilized herein, such passwords or tokens may be referred to as identity verification objects. Potential disadvantages of such identity verification objects may include being easily forgotten, lost, and/or stolen by a prospective impostor. Biometrics refers to a process for uniquely recognizing a person (or other biological entity) based upon one or more intrinsic physical or behavioral traits thereof. In effect, biometrics may replace the identity verification objects of traditional automatic identity verification systems with an identity verification attribute of a user. Thus, biometrics may eliminate the above disadvantages of forgotten, lost and/or stolen identity verification objects, since an identity verification attribute comprises an inherent characteristic of a user, with no requirement for further, external actualization.

Example physiological biometric identity verification techniques include fingerprint pattern matching and facial, hand geometry and/or iris recognition. These techniques may rely at least in part on unique characteristics of a relevant body part to identify a user. Thus, an imposter could create and use a counterfeit copy of the relevant body part to fool these techniques into permitting an unauthorized access to a controlled resource. However, it may be generally more difficult for a person to completely and/or accurately mimic the behavior of another person. This feature may be used in a number of behavioral identity verification techniques which may rely at least in part on measurable, identifying behaviors of registered users. Example behavioral identity verification techniques include voice and gait recognition.

Previous studies (Gaines, R. Lisowski, W., Press, S. and Shapiro, N. (1980), Authentication by keystroke timing: some preliminary results (Rand Report R-256-NSF). Santa Monica, Calif.: Rand Corporation) have shown that there may be a consistent temporal sequence to latencies between successive keystrokes each time a person types a word. Furthermore, the pattern of latencies may differ from one person to another. Thus, this feature may be used in typing pattern identity verification systems, which may not only recognize a typed password and/or username, but may also recognize the intervals between characters in the typed password and/or username, and the overall speeds and/or patterns with which the characters are typed.

Physiological biometric identity verification techniques may utilize a presentation of a relevant body part for verification of a user, although said body part might be removed from an authorized user by an impostor. However, a behavioral biometric identity verification technique may comprise an interaction with a live person. Thus, an impostor would need to present a live authorized user to a behavioral biometric identity verification system to gain access to a controlled resource. However, such a behavioral biometric identity verification technique has the disadvantage of not being able to discern whether the authorized user attempting to gain access to the controlled resource is requesting validation under duress, as would be the situation with an imposter controlling the authorized user, or whether the authorized user is making the request voluntarily.

One example embodiment of a biometric security technique in accordance with claimed subject matter may comprise generating a plurality of test keyboard metrics from a received identity verification request and may further comprise comparing a typing pattern expressed in the test keyboard metrics with those expressed in one or more stored keyboard metrics from a plurality of registered users. For this example embodiment, the technique further comprises refusing access to a controlled resource in the event the typing pattern expressed in the test keyboard metrics does not substantially match any of the typing patterns expressed in the stored keyboard metrics. In the event of a substantial match, the example technique comprises determining a closest matching registered user whose typing pattern most closely matches the typing pattern expressed in the test keyboard metrics. Also for the present example, the technique further comprises comparing the test keyboard metrics with one or more stored keyboard metrics associated with a normally stressed state of the closest matching registered user. In the event the typing pattern expressed in the test keyboard metrics substantially matches a keyboard pattern associated with the normally stressed state of the closest matching registered user, the example technique comprises allowing access to the controlled resource. The technique described above is merely an example, and the scope of claimed subject matter is not limited in this respect.

An example embodiment of an example biometric security system may comprise a keyboard metric calculator to generate a plurality of test keyboard metrics from a received identity verification request. The example biometric security system may further comprise an identity comparator to determine whether a typing pattern expressed in the test keyboard metrics substantially matches a typing pattern expressed in one or more stored keyboard metrics from a plurality of registered users. In the event the typing pattern expressed in the test keyboard metrics substantially matches a plurality of the typing patterns expressed in the stored keyboard metrics, the identity comparator may further establish a closest matching registered user whose typing patterns most closely match that of the test keyboard metrics.

Further, for the present example, the example biometric security system may comprise a stress state comparator to compare the test keyboard metrics with one or more stored keyboard metrics associated with a normally stressed state of the closest matching registered user. The system may further comprise an access controller to refuse access to a controlled resource in the event the typing pattern expressed in the test keyboard metrics does not substantially match any of the typing patterns expressed in the stored keyboard metrics. In the event a match is found, the access controller may allow access to the controlled resource in the event the typing pattern expressed in the test keyboard metrics substantially matches that associated with a normally stressed state of the closest matching registered user. Of course, this system is merely an example, and the scope of claimed subject matter is not limited in this respect.

For an additional example embodiment of a biometric security technique, an article such as a storage medium may have stored thereon instructions that, in response to being executed by a processor of a computing platform, result in the computing platform generating a plurality of test keyboard metrics from a received identity verification request and may also result in comparing a typing pattern expressed in the test keyboard metrics with those expressed in one or more stored keyboard metrics from a plurality of registered users. Also for this example embodiment, the storage medium may have stored thereon further instructions that, in response to being executed by the processor, result in the computing platform refusing access to a controlled resource in the event the typing pattern expressed in the test keyboard metrics does not substantially match any of the typing patterns expressed in the stored keyboard metrics.

In addition, for the present example, the storage medium may have stored thereon further instructions that, in response to being executed by the processor, further result in the computing platform, in the event of a substantial match, determining a closest matching registered user whose typing pattern most closely matches the typing pattern expressed in the test keyboard metrics. Also for the present example, the storage medium may have stored thereon further instructions that, in response to being executed by the processor, further result in the computing platform comparing the test keyboard metrics with one or more stored keyboard metrics associated with a normally stressed state of the closest matching registered user. The storage medium may further have stored thereon instructions that, in response to being executed by the processor, allow access to the controlled resource in the event the typing pattern expressed in the test keyboard metrics substantially matches a keyboard pattern associated with the normally stressed state of the closest matching registered user. Of course, the embodiment described above is merely an example, and the scope of claimed subject matter is not limited in this respect.

The examples described above may be utilized in a number of applications. For example, in an example embodiment, an automated teller machine may comprise a biometric security system in accordance with claimed subject matter. Similarly, in an additional example embodiment, a door entry system may comprise a biometric security system in accordance with claimed subject matter. Additionally, an example embodiment may include a portable wireless device comprising a biometric security system in accordance with claimed subject matter. Of course, these are merely examples of applications in which embodiments of biometric security systems may be implemented, and the scope of claimed subject matter is not limited in this respect. Also, as used herein, the term computing platform refers to any electronic device capable of executing instructions. Example computing platforms may include, but are not limited to, desktop computers, notebook computers, portable wireless devices, cellular telephones, personal digital assistants, gaming consoles, consumer media devices such as televisions and digital video devices, ATM machines, and door entry security systems. However, these are merely several examples of a computing platform, and the scope of claimed subject matter is not limited in this respect.

In contrast with many biometric security systems which utilize specialized hardware components (e.g. retinal scanner, etc.), the example embodiments of biometric security systems described herein may perform user identification operations through differential timings of keystrokes. Thus, at least some embodiments in accordance with claimed subject matter may not utilize specialized hardware, but rather may utilize a conventional keyboard and a timing system, for example.

In an embodiment, differential keystroke timings in one or more passwords provided by the user may be examined. Thus, in further contrast with many conventional biometric security systems that do not allow a biometric feature of interest to be readily changed, the biometric security embodiments described herein allow for a password to be easily changed. For example, it may be advantageous to change a password if a user or other authority suspects that the user's typing pattern is being imitated by a would-be imposter.

Previous studies have shown that a sad mood induces a more monotonous and slower speech pattern compared to a happy mood (Barrett, J., and Paus, T. (2002). Experimental Brain Research, 146(4), 531-537). Previous studies have also shown that emotional stress or anxiety can affect the execution of a simple motor task resulting in a more varied application of force (Noteboom, J. T., Fleshner, M., and Enoka, R. M. (2001). Journal of Applied Physiology, 91(2), 821-83)] or timing (Coombes, S. A., Janelle, C. M., and Duley, A. R. (2005). Journal of Motor Behaviour, 37(6), 425-436).

Embodiments in accordance with claimed subject matter may utilize these above observations in novel and innovative biometric security techniques that not only verify the identity of a would-be user, but that also provide an indication of the stress level of the user at that time. An indication that the user is unusually highly stressed may provide a warning that the user is acting under duress or is aware that he/she is doing something unwise or illicit. This warning may activate an additional security protocol to further investigate the circumstances of the user's identity verification request before granting access to the user. It may also initiate procedures for protecting the user (e.g. alerting the police that the user is possibly in danger).

An example embodiment of a biometric security process may be broadly divided into an offline processing phase and an online processing phase. During the offline processing phase, a user may be registered with the biometric security system; and relevant identifying and emotional state indicator metrics may be determined for the user. Such a determination may be made from an analysis of one or more typing patterns for the user while the user is exposed to conditions selected to induce a normal stress level, and in some embodiments a relatively high stress level. During the online processing phase, the example biometric security process uses the afore-mentioned identifying and emotional state metrics to process a password and/or username, for example, provided by the user, thereby verifying the identity and assessing the substantially current stress level of the user.

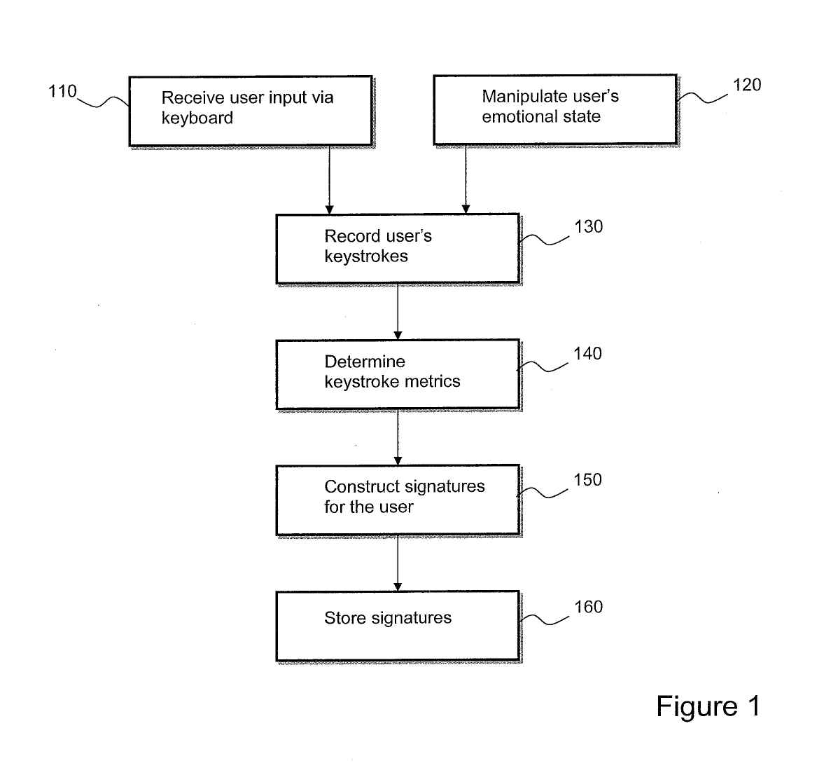

FIG. 1 depicts a flowchart illustrating an example offline processing phase of an example embodiment of a biometric security technique. At block 110, the example offline processing phase may begin by receiving keyboard-related input from a user. To receive the input from the user, the user may type on a keyboard and may type one or more textual elements one or more times. In an embodiment, the textual element may comprise a fixed-length element. Further for an embodiment, one or more of the textual elements may comprise a password and/or a user name associated with the user. The textual elements typed by the user may be referred to as a registration entry. In addition, for an embodiment, at least some of the textual elements may be displayed to the user on a display screen, and the user may be prompted to type the displayed textual elements. Additionally, for one or more embodiments, at least some of the textual elements may be made audible to the user through an audio component of the biometric security system. In such a situation, the user may be prompted to input via the keyboard the textual elements made audible to the user.

At block 130 of the present example process, the keystrokes received from the user via the keyboard as described above may be recorded. In an embodiment, one or more signals indicative of information related to the received keystrokes may be stored in a memory. As noted above, the user may be prompted to input a registration entry via the keyboard. One or more signals indicative of keystroke metrics including temporal information and force information may be stored in the memory. The force information may be determined by measuring the force with which the user depresses individual keys as the user is typing the registration entry. The recorded raw temporal, force, and keystroke information from the registration entry may be referred to herein as primary keyboard entry data.

At block 120 of the present example process, the user's emotional state may be manipulated while the user is typing the registration entry. In another embodiment, the user's emotional state may be manipulated prior to the user typing the registration entry, and in another embodiment the user's emotional state may be manipulated both prior to and during the typing of the registration entry. Further, in an embodiment, a normal stress state may be induced in the user. In a further embodiment, a higher stress state may be induced in the user in addition to the normal state. To affect an emotional state in a user, an example embodiment of a biometric security process may comprise exposing the user to a number of sounds selected from an International Affective Digitized Sound (IADS, [Bradley, M. M., and Lang, P. J. (1999). International Affective Digitized Sounds (IADS): Stimuli, Instruction Manual and Affective Ratings (Tech. Rep. No. B-2). Gainesville, Fla.: The Center for Research in Psychophysiology, University of Florida]) system. In an embodiment, a normal stress state may be induced by exposing the user to one or more so-called neutral or non-arousing everyday sounds. Such sounds may include, for example, a sound made by a toothbrush, an electric fan, or paper being crumpled. A higher stress state may be induced by exposing the user to a one or more sounds rated as being both extremely arousing and extremely unpleasant (e.g. an argument, baby crying, bee-buzzing or sirens). However, these are merely examples of sounds that may induce normal and/or higher stress states in users, and the scope of claimed subject matter is not limited in this respect. In addition, sounds utilized in various embodiments in accordance with claimed subject matter are not limited to those from the IADS catalogue.

Additionally, embodiments of biometric security techniques in accordance with claimed subject matter are not restricted to using sound to induce a normal or higher stress state in a user. In particular, various embodiments in accordance with claimed subject matter may use other mechanisms for inducing different stress states. Some examples include, but are not limited to, temperature, galvanic stress, and/or variable lighting conditions such as variable strobe frequencies. It will be further understood that even when using sound to induce different stress states, the biometric security method is not limited to selecting sounds from the IADS system. Instead, sounds from other sources may be alternatively or additionally be used.

One or more embodiments may also comprise acquiring confirmatory data as to whether a higher stress state is actually induced in the user by measuring a galvanic skin response (GSR) of the user while the user is typing. To measure GSR in an embodiment, one or more electrodes may be attached to the skin of the user to measure the conductivity thereof. Electrical skin conductance is dependent on the activity of sweat glands which, since they are innervated by the autonomic nervous system, is often used as an indicator of sympathetic activity related to emotional processing of stimuli. In particular, the user's skin's conductivity may increase in the event the user becomes stressed. It will be appreciated that the biometric security techniques in accordance with claimed subject matter are not limited to using GSR for confirmation of the induction of a higher stress state. On the contrary, one or more embodiments in accordance with claimed subject matter may detect the induction of a particular stress state from other physiological variables, such as, altered pulse rate, blood pressure, pupil dilation, body temperature and respiration, to name but a few examples. Of course, the scope of claimed subject matter is not limited in this respect.

Continuing with the example embodiment depicted in FIG. 1, at block 140 a plurality of keystroke metrics may be calculated from the received primary keyboard entry data to calculate a plurality of keystroke metrics. For one or more embodiments, the calculated keyboard metrics may include inter-key latency times. As used herein the term inter-key latency refers to a length of time between releasing one key and pressing the next, which could be negatively valued in the event of an overlap between the depression of successive keys. Also for one or more embodiments, the calculated keystroke metrics may include hold times and/or typing error measurements. As used herein, the term hold time refers to a length of time a key is held down. These keystroke metrics are merely examples, and the scope of claimed subject matter is not limited in this respect. In one or more embodiments, other keystroke metrics may be utilized to characterize the primary keyboard entry data.

At block 150 of the example depicted in FIG. 1, a plurality of identifying signatures for the user may be calculated, wherein at least some of the identifying signatures are associated (optionally through the previously acquired confirmatory data) to one or more particular stress levels of the user. In an embodiment, the signatures may be associated with the use of the confirmatory data, although the scope of claimed subject matter is not limited in this respect. Also for an embodiment, to visualize the signatures, the signatures may be represented by, for example, simple graphs or multi-dimensional modalities, although the scope of claimed subject matter is not limited in this respect. At block 160 of the present example process, identifying signatures constructed for the respective individual users of the plurality of users registered with the biometric security system may be stored. For an embodiment, the signatures may be stored in a memory of a computing platform. The identifying signatures may be used during a subsequent online processing phase of the present example biometric security process to determine whether a would-be user of the biometric security system is actually registered therewith. Embodiments in accordance with claimed subject matter may contain all, fewer than, or more than blocks 110-160. Further, the order of blocks 110-160 is merely an example order, and the scope of claimed subject matter is not limited in this respect.

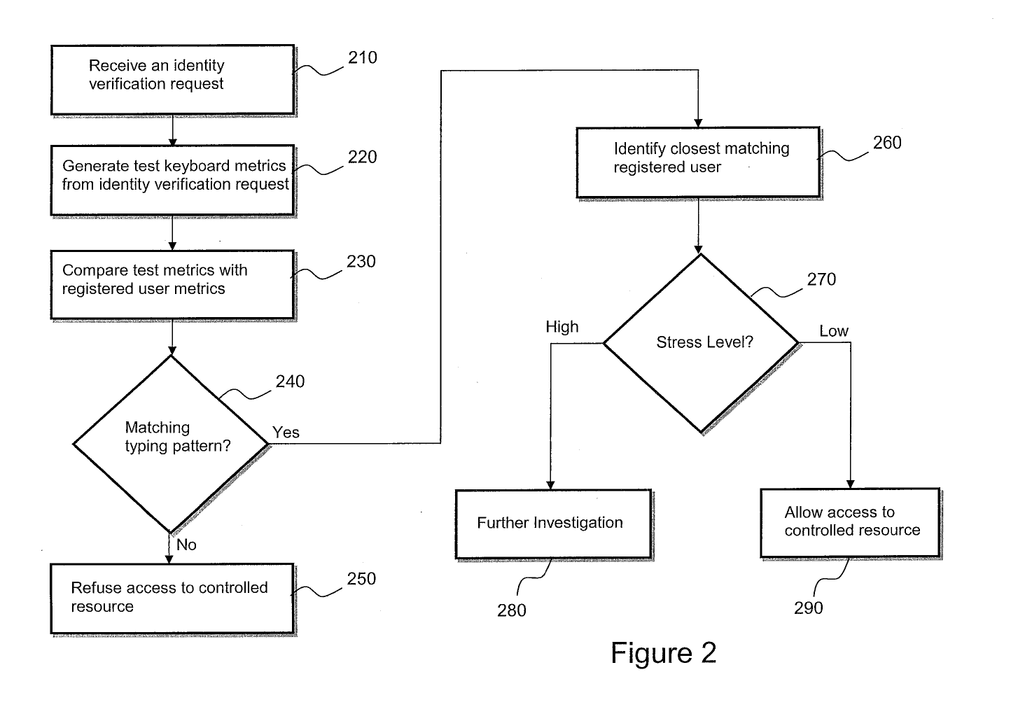

FIG. 2 is a flowchart depicting an example online processing phase of an example embodiment of a biometric security technique. At block 210, an identity verification request may be received from a user. For one or more embodiments, the identity verification request may comprise one or more fixed length textual elements typed by the user in response to a prompt from a biometric security system. At least in part in response to receiving the identity verification request, the request may be analyzed, and at block 220 a plurality of keyboard metrics corresponding with those generated during the offline processing phase may be generated in accordance with, and at least in part in response to, the analyzed request. For simplicity, the keyboard metrics generated during the offline processing phase and the online processing phase may be referred to herein as registered user metrics and test metrics, respectively.

Continuing with the present example embodiment, a matching algorithm may be utilized at block 230 to compare the test metrics with the registered user metrics to generate a similarity measure. In an embodiment, the matching algorithm may comprise one or more of a statistical vector comparison method such as a nearest neighbor algorithm, a Bayesian classifier, and an artificial neural network. However, the scope of claimed subject matter is not limited in this respect. Utilizing the similarity measure, it may be determined at block 240 whether the typing patterns expressed in the identity verification request correspond with any of those of the registered users of the biometric security system.

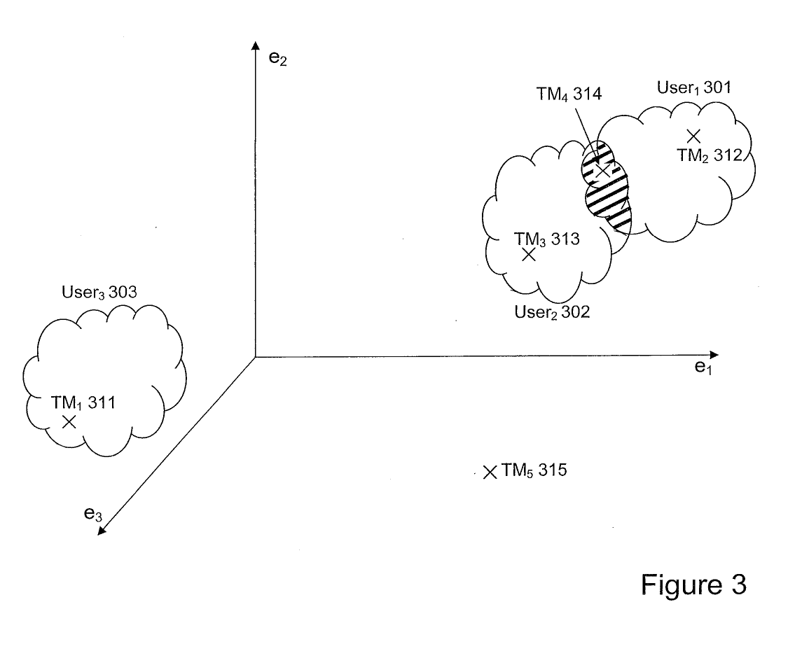

FIG. 3 is a diagram illustrating an example three-dimensional distribution of signatures acquired from a plurality of users. For one or more embodiments, a plurality of users may be registered with an example biometric security system. While the number of users that may be registered with the system are not limited to any particular count, for the purposes of ease of explanation and ease of understanding the present example is limited to three users, referred to as User₁ 301, User₂ 302 and User₃ 303. As depicted in FIG. 3, a plurality of identifying signatures of a given registered user forms a data cloud within the hyperspace defined by the above-mentioned keystroke metrics. The volume of a given data cloud is at least partially a manifestation of different stress states associated with the user. In the present example, the hyperspace is shown as a three-dimensional space, wherein, for example, the e₁, e₂ and e₃ dimensions respectively represent an “a” to “e” inter-key latency time, an “h” key holding time, and a “t” key holding time. Of course, these are merely example keystroke metrics, and the scope of claimed subject matter is not limited in this respect.

It should be appreciated that the situation depicted in FIG. 3 is provided for example purposes only, and should be interpreted accordingly. In particular, neither FIG. 3 nor the accompanying textual description thereof should be in any way construed as limiting claimed subject matter to the depicted and described number of registered users and/or number of hyperspace dimensions utilized in example embodiments described herein. To the contrary, the example biometric security techniques described herein are capable of accommodating any number of registered users and of calculating any number of different keystroke metrics from the typing patterns of a given registered user.

Returning to the example depicted in FIG. 3, the data cloud for User₃ 303 is well separated from that of User₁ 301 and User₂ 302. However, the data cloud of User₁ 301 partially overlaps with that of User₂ 302. A test metric TM₁ 311 is disposed proximally to the User₃ 303 data cloud. Thus, it can be surmised that the User₃ 303 and not User₁ 301 or User₂ 302 made the identity verification request from which the test metric TM₁ 311 was generated. Similarly, test metrics TM₂ 312 and TM₃ 313 are respectively disposed proximally to the non-overlapping regions of the User₁ 301 and User₂ 302 data clouds. Thus, it can be surmised that User₁ 301 and User₂ 302 respectively made the identity verification requests from which the test metrics TM₂ 312 and TM₃ 313 were generated. However, the test metric TM₄ 314 is disposed proximally to the overlapping regions of the User₁ 301 and User₂ 302 data clouds. At least in part in response to the test metric in the overlapping region, a probabilistic measure of the extent to which the identity verification request was made by either User₁ or User₂ may be provided. In contrast, the test metric TM₅ 305 is disposed distally from any of the registered user data clouds. Thus, it is very likely that the identity verification request was not made by a registered user of the biometric security system.

Returning to the example process depicted in FIG. 2, at least in part in response to a determination at block 240 that there is no close match between the test metrics and any of the registered user metrics, access to a controlled resource may be refused at block 250. However, at least in part in response to a determination at block 240 that there is a close match between the test metrics and at least one of the registered user metrics, the closest matching registered user may be determined at block 260. In another embodiment, the operations at blocks 230 and 240 may be replaced with a comparison of the textual elements of the identity verification request with those of the registration entries. Access to the controlled resource may be refused at block 250 in the event a close match is not found between the identity verification request (e.g. password and/or username entered by the user) and substantially any of the registration entries (e.g. passwords and/or usernames previously provided by registered users).

Further, for the present example embodiment, at block 270 the test metrics may be utilized to determine the likely stress state of the registered user on making the identity verification request. In one embodiment, the test keyboard metrics may be compared with one or more stored keyboard metrics associated with a normal stress state of the user. A significant deviation between the typing patterns expressed in the test keyboard metrics and those in the stored keyboard metrics may be an indication that the corresponding identity verification request from which the test keyboard metrics were derived was created under stress or duress.

In another embodiment, the test keyboard metrics may be compared with one or more stored keyboard metrics associated with a high stress state as well as a normal stress state of the closest matching registered user. From these comparisons, it may be determined at block 270 whether the typing pattern expressed in the test keyboard metrics more closely matches that associated with a high or normal stress state of the closest matching registered user. For example, referring to FIG. 3, let User₃ 303 have a high valued “t” key holding time, when typing in a highly stressed state. In other words, User₃ 303 had a highly-valued e₃ test metric when highly stressed. Because the TM₁ 311 test metric is disposed proximal to the highly-valued e₃ periphery of the User₃ 303 data cloud, it is likely that User₃ 303 was highly stressed when making the relevant identity verification request. It should be noted that the current example is a relatively very simple example to permit ease of explanation and understanding, and that for one or more embodiments a representation of a highly-stressed state for a user is likely to be manifested in multiple correlated test metrics. However, the scope of claimed subject matter is not limited to any particular number or type of test metrics.

Returning once more to FIG. 2, at least in part in response to a determination at block 270 that the registered user was in a normal stress state upon making the identity verification request, access to the controlled resource may be allowed at block 290. However, at least in part in response to a determination at block 270 that the registered user was in a highly stressed state on making the identity verification request, further investigations of the circumstances of the identity verification request may be undertaken at block 280. Embodiments in accordance with claimed subject matter may contain all, fewer than, or more than blocks 210-290. Further, the order of blocks 210-290 is merely an example order, and the scope of claimed subject matter is not limited in this respect.

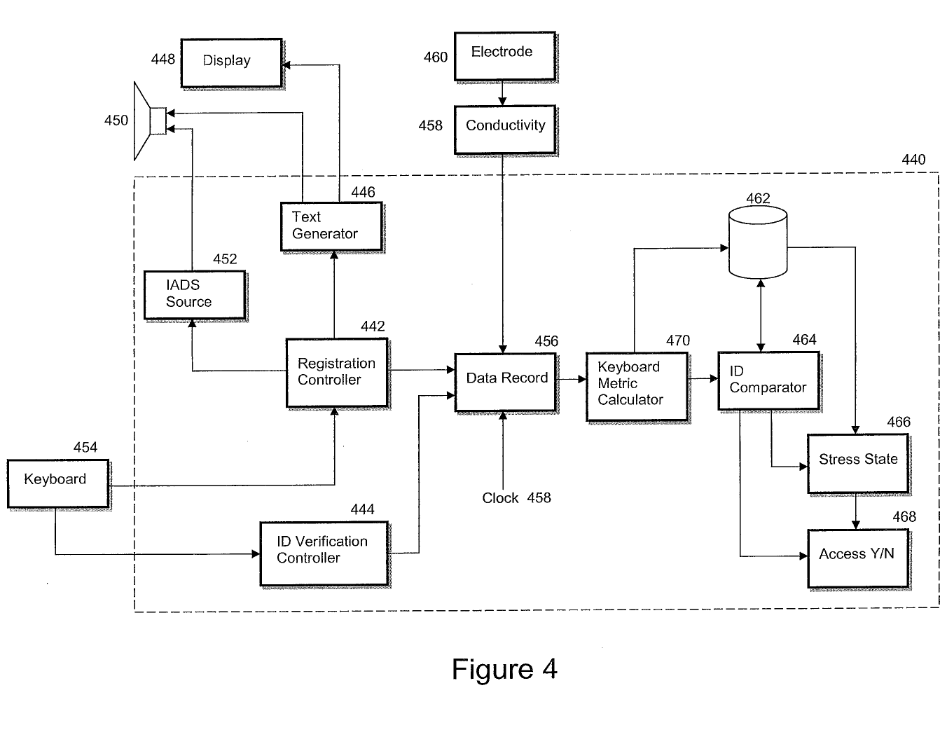

FIG. 4 is a schematic block diagram illustrating an example embodiment of a biometric security system 440. System 440 for this example embodiment represents an example computing platform. Biometric security system 440 for this example embodiment may comprise a registration controller 442 and an identity verification controller 444 to execute software and/or firmware instructions to control and execute offline user registration and online identity verification phases of biometric security techniques such as those example embodiments described above. Additionally, one or both of controllers 442 and 444 may comprise a memory to store instructions. In another embodiment, a memory device may be located elsewhere in system 440, from which controllers 442 and/or 444 may fetch instructions.

Registration controller 442 for this example is coupled with a text generator module 446. Text generator module 446 may receive an activation signal from registration controller 442, and at least in part in response to the activation signal the text generator module 446 may select one or more textual elements to be typed by a prospective registrant utilizing biometric security system 440. Text generator module 446 for this example embodiment is further coupled to a display 448 and/or a speaker/headphones 450, which may be utilized, in one or more embodiments, to respectively display or play a visual or audio representation of a textual element to be typed by the prospective registrant.

Also for the present example embodiment, registration controller 442 may further be coupled to an IADS source 452 comprising a repository of audio files of sounds selected and rated in accordance with the IADS protocol. Registration controller 442 may select audio files from the IADS source 452. In an embodiment, the audio files may be selected in a counter-balanced order, although the scope of claimed subject matter is not limited in this respect. The audio files may be selected with the aim of inducing high and/or normal stress states in the prospective registrant. Additionally, registration controller 442 may transmit a selection control signal to IADS source 452 to direct IADS source 452 to select a specified audio file from its repository. Also for the present example embodiment, IADS source 452 may be further coupled to speaker/headphones 450. In this manner, speaker/headphones 450 may receive an audio file specified by registration controller 442 from IADS source 452 and may play the audio file to the prospective registrant.

For the present example embodiment depicted in FIG. 4, registration controller 442 and identity verification controller 444 are coupled to a keyboard 454. Controllers 442 and 444 may receive one or more keystroke signals from keyboard 454 at least in part in response to a prospective registrant or user making an identity verification request of the biometric security system 440 by typing on keyboard 454. Keyboard 454 may comprise a conventional computer keyboard in an embodiment, or in other embodiments may comprise a specially adapted keyboard dedicated to the task of receiving identity verification requests. A user making an identity verification request of the biometric security system 440 may be referred to herein as an access requester, which may be differentiated from a prospective registrant making a registration entry of the biometric security system 440.

Further, for the example embodiment depicted in FIG. 4, registration controller 442 and identity verification controller 444 are also coupled to a data recorder module 456. Data recorder module 456 may receive the afore-mentioned keystroke signals from the controllers 442 and 444 and may further receive the afore-mentioned selection control signals from registration controller 442. Data recorder module 456 for this embodiment may further receive a clock signal 458 which may provide time-keeping signals to module 456. Data recorder module 456 may further use the time-keeping signals to calculate relative timings of the keystroke signals received from controllers 442 and 444, and may at least in response to calculating the relative timings form a keystroke profile for the prospective registrant or the access requester.

In an embodiment, data recorder module 456 may also be coupled to a force measuring sensor (not shown) which may measure the force with which the prospective registrant and/or the access requester depresses individual keys on keyboard 454 when typing a registration entry or identity verification request. For such an embodiment utilizing a force measuring sensor, data recorder module 456 may supplement the relative timings of the keystroke signals with the force measurements to form a more complete keystroke profile of a prospective registrant and/or access requester.

Data recorder module 456 may also receive the afore-mentioned selection control signals transmitted by registration controller 442 to IADS source 452. Furthermore, data recorder module 456 may be optionally coupled with one or more skin conductivity sensors 458 comprising one or more electrodes 460. Electrodes 460 and/or skin conductivity sensors 458 may attach to the skin of a prospective registrant and may detect changes in the conductivity of the skin. For such an embodiment utilizing electrodes and/or skin conductivity sensors, data recorder module 456 may receive conductivity measurement data from conductivity sensor 458, and may use the conductivity measurement data to confirm that the selection control signals received from the registration controller 442 are correlated with an actual stress state in the prospective registrant.

Biometric security system 440 further comprises, in an embodiment, a keyboard metric calculator 470 to receive a keystroke profile comprising the calculated relative timings of keystroke signals from data recorder module 456 along with a flag indicating whether the keystroke profile is derived from a prospective registrant or from an access requester. Similarly, keyboard metric calculator 470 may further receive selection control signals and, optionally, conductivity measurement data, from data recorder module 456.

In an embodiment, keyboard metric calculator 470 may be coupled with a keystroke profile database 462 and with an identity comparator 464 which is also coupled in a feedback loop with keystroke profile database 462. Keystroke profile database 462 may comprise a memory device, for an embodiment. Keyboard metric calculator 470 may, at least in part in response to a receipt of a flag indicating that an associated keystroke profile is derived from a prospective registrant, correlate the calculated relative keystroke timing components of the keystroke profile with the selection control signals. Additionally, in an embodiment, keyboard metric calculator 470 may correlate the calculated relative keystroke timing components of the keystroke profile with conductivity measurement data. Keyboard metric calculator 470 may further store a record for the relevant prospective registrant in the keystroke profile database 462 in an embodiment.

Similarly, keyboard metric calculator 470 may, at least in part in response to receiving a flag indicating that an associated keystroke profile is derived from an access requester, transmit the keystroke profile to identity comparator 464. Identity comparator 464 may interrogate keystroke profile database 462 to ascertain whether the received keystroke profile bears any similarity to those stored in keystroke profile database 462. In an embodiment, the similarity determination may be based at least in part on the basis of a proximity measure formed in a hyperspace defined by the keystroke variables stored in keystroke profile database 462.

At least in part in response to a close match not being found, identity comparator 464 may activate an access controller 468 to refuse the access requester access to a desired resource. However, in the event of the identification of a one or more close matches, keystroke profile database 462 may return details of the associated registered users to identity comparator 464, for one or more embodiments.

Identity comparator 464, in an example embodiment, may perform a further filtration process at least in part in response to a receipt of the details in order to determine a single most closely matching keystroke profile and to assign the access requester the identity of the relevant most closely matching registered user. Similarly, identity comparator 464 may further be coupled with a stress state determining module 466 and may transmit the details to stress state determining module 466 at least in part in response to receiving the details of the most closely matching registered users. Stress state determining module 466 is coupled, in turn, to keystroke profile database 462 and access controller 468. In an embodiment, stress state determining module 466 may interrogate keystroke profile database 462 by comparing the keystroke profile of the access requester with those of the closest matching registered users at least in part in response to receiving the details of the closest matching registered users. Further, stress state determining module 466 may use a similarity measure with the relevant data clouds to ascertain the high or normal stress state of the access requester.

In the example embodiment depicted in FIG. 4, stress state determining module 466 may transmit a first flag indicating a normal stress state to access controller 468 at least in part in response to determining that the access requester was in the normal stress state when making the access request. Access controller 468 may, at least in part in response to receiving the first flag, grant the access requester access to the desired resource. However, stress state determining module 466 may further transmit a second flag indicating a high stress state to access controller 468 at least in part in response to determining that the access requester was in a highly stressed state when making the access request. Access controller 468 may further, at least in part in response to receiving the second flag, activate a module (not shown) to perform further investigations before transmitting the first flag to access controller 468 to allow the access requester access to the required resource. Alternatively, access controller 468 may issue a communication to ID verification controller 444 in response to receiving the second flag to deny the access requester access to the desired resource.

Contrastingly, in an example embodiment, keystroke profile database 462 may return a third flag to identity comparator 464 at least in part in response to a failure to identify a close match between a received keystroke profile of an access requester and any of the keystroke profiles in keystroke profile database 462. Identity comparator 464 may, at least in part in response to receiving such a flag, transmit a denial signal (not shown) to identity verification controller 444. Identity verification controller 444 may, at least in part in response to receiving the denial signal, issue a communication to this effect through display 448 to the access requester, and may further deny the access requester access to the desired resource.

While the example illustrated in FIG. 4 is depicted with a specific arrangement of components, other embodiments in accordance with claimed subject matter may include all, less than, or more than the components depicts in FIG. 4 and/or discussed above. Further, the specific arrangement of the various components depicted in FIG. 4 is merely an example arrangement, and the scope of claimed subject matter is not limited in this respect. Additionally, although biometric security system 440 in an embodiment comprises a special purpose system, other embodiments may be implemented using other types of computing platforms, including general purpose computing platforms that may become specific machines for accomplishing biometric security operations as described above at least in part in response to a plurality of instructions being executed by a processor of the computing platform.

For an example, a statistical test was developed to determine whether there is a significant difference between the responses of different users. More particularly, for the example test, 70 keyboard variables may be determined from keyboard data acquired from five different users. The 70 keyboard variables for this example comprise 36 hold times and 34 inter-key latency times.

For the example test, the responses of two persons may be divided into two groups. The mean of the variances in each group may be calculated. In the event each group corresponds to the responses of a single person, the mean variance should usually be less than when the cases are randomly assigned to groups. For the present example, how often the correct assignment to groups results in lower mean variance than random assignments to groups corresponds to a P value.

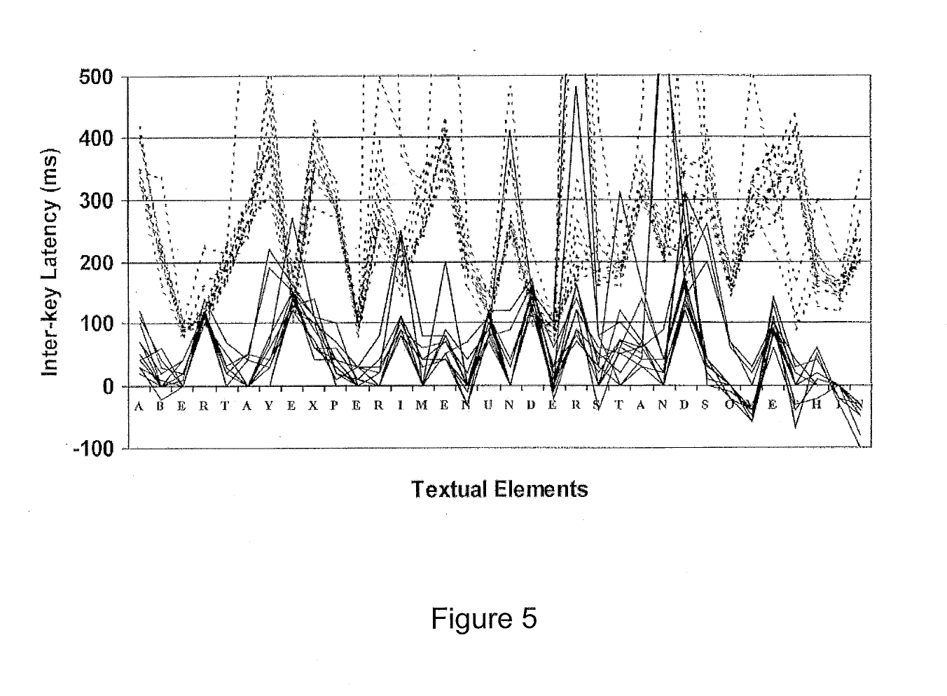

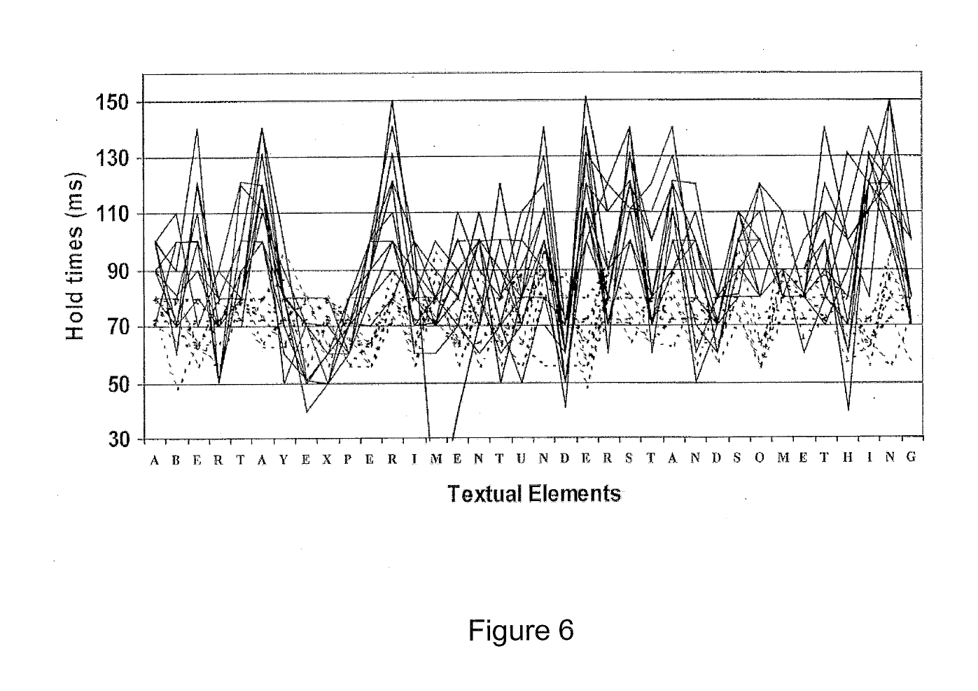

In the present example, pair-wise comparisons were made between all 35 people in a pilot study. In all cases P<0.001. Thus, for the present example, one may be very confident that all of these people have distinct keystroke signatures. This was true for hold times and latencies together, for latencies only, and for hold times only. Indeed, referring to FIG. 5, considerable and relatively stable differences may be seen between the inter-key latency times of the first and second users. Similarly, referring to FIG. 6, it may be seen that the variance of the hold times of a first user significantly differs from those of the second user.

Considering the determination of the stress state condition of the users, the data from the present example shows a significant difference between neutral and stressed conditions. This is so for hold times and latencies together, for hold times only, and for latencies only. For the present example:
for holds and latencies: P<0.002;
holds only: P<0.003; and
latencies only P<0.002.

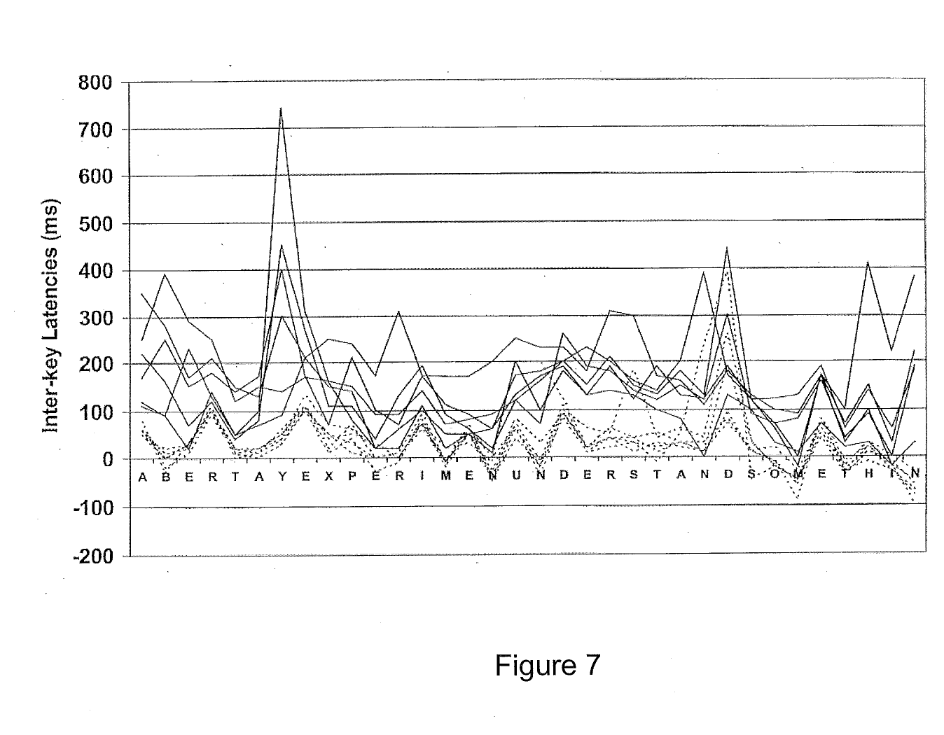

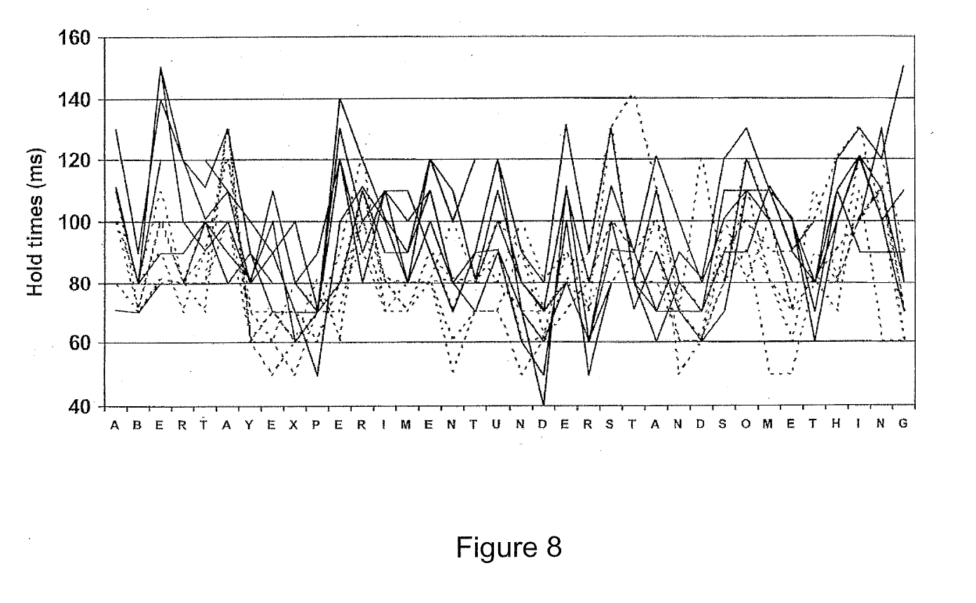

Further, referring to FIGS. 7 and 8, it may be seen that the timings of key presses and the timings of how long each key is held down are significantly altered in the presence of stress, thus indicating that keystroke dynamics may be used to identify anomalous on-line behavior. Of course, the results depicted in FIGS. 5-8 are merely example data presented for explanatory purposes, and the scope of claimed subject matter is not limited in these respects. Further, although the results depicted in FIGS. 6-8 are relatively clear, a study of other groups of people may yield less clear differences between stressed and unstressed conditions, for example.

It should be noted that the above-described example embodiments for biometric security have a vast range of potential applications to any environment in which it is necessary or desirable to control access to a resource and to prevent un-authorized access thereto. More particularly, but not exclusively, the biometric security system and method may be used in automated teller machines, door entry systems, and/or wireless devices such as mobile phones, personal digital assistants, etc. Similarly, embodiments in accordance with claimed subject matter may be used for validating credit card numbers and/or bank account numbers if such numbers are used online or entered using a touch-tone phone, to name but a couple additional potential applications. Of course, the above-mentioned applications are merely examples, and the scope of claimed subject matter is not limited in this respect.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference throughout this specification to “one embodiment” or “an embodiment” may mean that a particular feature, structure, or characteristic described in connection with a particular embodiment may be included in at least one embodiment of claimed subject matter. Thus, appearances of the phrase “in one embodiment” or “an embodiment” in various places throughout this specification are not necessarily intended to refer to the same embodiment or to any one particular embodiment described. Furthermore, it is to be understood that particular features, structures, or characteristics described may be combined in various ways in one or more embodiments. In general, of course, these and other issues may vary with the particular context of usage. Therefore, the particular context of the description or the usage of these terms may provide helpful guidance regarding inferences to be drawn for that context.

Likewise, the terms, “and,” “and/or,” and “or” as used herein may include a variety of meanings that also is expected to depend at least in part upon the context in which such terms are used. Typically, “or” as well as “and/or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example.

Embodiments disclosed herein may be implemented in hardware, such as implemented to operate on a device or combination of devices, whereas another embodiment may be implemented in software. Likewise, an embodiment may be implemented in firmware, or as any combination of hardware, software, and/or firmware, for example.

Likewise, although the scope of claimed subject matter is not limited in this respect, one embodiment may comprise one or more articles, such as a storage medium or storage media. This storage medium may have stored thereon instructions that if executed by a computing platform, such as a computer, a computing system, an electronic computing device, a cellular phone, a personal digital assistant, and/or other information handling system, for example, may result in an embodiment of a method in accordance with claimed subject matter being executed, for example. The terms “storage medium” and/or “storage media” as referred to herein relate to media capable of maintaining expressions which are perceivable by one or more machines. For example, a storage medium may comprise one or more storage devices for storing machine-readable instructions and/or information. Such storage devices may comprise any one of several media types including, but not limited to, any type of magnetic storage media, optical storage media, semiconductor storage media, disks, floppy disks, optical disks, CD-ROMs, magnetic-optical disks, read-only memories (ROMs), random access memories (RAMs), electrically programmable read-only memories (EPROMs), electrically erasable and/or programmable read-only memories (EEPROMs), flash memory, magnetic and/or optical cards, and/or any other type of media suitable for storing electronic instructions, and/or capable of being coupled to a system bus for a computing platform. However, these are merely examples of a storage medium, and the scope of claimed subject matter is not limited in this respect.

The term “instructions” as referred to herein relates to expressions which represent one or more logical operations. For example, instructions may be machine-readable by being interpretable by a machine for executing one or more operations on one or more data objects. However, this is merely an example of instructions, and the scope of claimed subject matter is not limited in this respect. In another example, instructions as referred to herein may relate to encoded commands which are executable by a processor having a command set that includes the encoded commands. Such an instruction may be encoded in the form of a machine language understood by the processor.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

What is claimed is:

1. A biometric security method, comprising:
generating a plurality of test keyboard metrics from a received identity verification request;
comparing a typing pattern expressed in the received identity verification request with those expressed in a one or more stored entries from a plurality of registered users;
refusing access to a controlled resource in the event the typing pattern expressed in the received identity verification request does not substantially match any of those expressed in the stored entries, and, in the event the typing pattern expressed in the received identity verification request does substantially match the or each typing pattern expressed in a one or more of the stored entries, determining a closest matching registered user whose typing pattern most closely matches that expressed in the received identity verification request;
comparing the test keyboard metrics with a one or more stored keyboard metrics associated with a normally stressed state of the closest matching registered user; and
allowing access to the controlled resource in the event the typing pattern expressed in the test keyboard metrics substantially matches that associated with a normally stressed state of the closest matching registered user.

2. The biometric security method as claimed in claim 1 wherein said comparing a typing pattern expressed in the received identity verification request with those expressed in a one or more stored entries from a plurality of registered users comprises comparing a typing pattern expressed in the test keyboard metrics with those expressed in a one or more stored keyboard metrics from a plurality of registered users;
said refusing access to a controlled resource in the event the typing pattern expressed in the received identity verification request does not substantially match any of those expressed in the stored entries, and, in the event, the typing pattern expressed in the received identity verification request does substantially match the or each typing pattern expressed in a one or more of the stored entries, determining a closest matching registered user whose typing pattern most closely matches that expressed in the received identity verification request, comprises refusing access to a controlled resource in the event the typing pattern expressed in the test keyboard metrics does not substantially match any of those expressed in the stored keyboard metrics, and, if the typing pattern expressed in the test keyboard metrics does substantially match any of those expressed in the stored keyboard metrics, determining a closest matching registered user whose typing pattern most closely matches that expressed in the test keyboard metrics.

3. The biometric security method as claimed in claim 2, wherein said generating a plurality of test keyboard metrics from a received identity verification request comprises calculating at least one metric selected from the set comprising an inter-key latency time, a hold time and a typing error measurement.

4. The biometric security method as claimed in claim 2, wherein said comparing a typing pattern expressed in the test keyboard metrics with those expressed in a one or more stored keyboard metrics, comprises using a matching algorithm to generate a similarity measure between the test keyboard metrics and the stored keyboard metrics.

5. The biometric security method as claimed in claim 1, wherein said comparing the test keyboard metrics with a one or more stored keyboard metrics associated with a normally stressed state of the closest matching registered user comprises comparing the test keyboard metrics with a one or more stressed keyboard metrics associated with a more highly stressed state of the closest matching registered user.

6. The biometric security method as claimed in claim 2, wherein the method comprises initiating an investigation into the received identity verification request, in the event the typing pattern expressed in the test keyboard metrics most closely matches that associated with the more highly stressed state of the closest matching registered user.

7. The biometric security method as claimed in claim 1 wherein the method further comprises:
requiring a prospective registered user to type a one or more textual elements;
manipulating an emotional state of the prospective registered user while the prospective registered user is typing;
recording a one or more keystrokes of the prospective registered user;
calculating a plurality of test keyboard metrics from the recorded keystrokes; and
storing the test keyboard metrics.

8. The biometric security method as claimed in claim 7 wherein said recording the keystrokes of the prospective registered user comprises measuring a force with which the prospective registered user depresses a one or more keys of a keyboard when typing the or each textual element.

9. The biometric security method as claimed in claim 7, wherein said manipulating the emotional state of the prospective registered user comprises manipulating the emotional state of the prospective registered user before the prospective registered user starts typing.

10. The biometric security method as claimed in claim 7, wherein said manipulating the emotional state of the prospective registered user comprises inducing a normal stress state in the prospective registered user.

11. The biometric security method as claimed in claim 10, wherein said manipulating an emotional state of the prospective registered user comprises inducing a more highly stressed state in the prospective registered user.

12. The biometric security method as claimed in claim 7, wherein said manipulating an emotional state of the prospective registered user comprises exposing the prospective registered user to a plurality of stimulating sounds.

13. The biometric security method as claimed in claim 7, wherein said manipulating an emotional state of the prospective registered user comprises exposing the prospective registered user to a plurality of non-arousing sounds.

14. The biometric security method as claimed in claim 12 or claim 13 wherein said exposing the prospective registered user to a plurality of stimulating sounds or non-arousing sounds comprises exposing the prospective registered user to a plurality of sounds selected from an International Affective Digitized Sound (IADS) system.

15. The biometric security method as claimed in claim 7, wherein said recording the keystrokes of the prospective registered user comprises measuring a galvanic skin response of a prospective registered user.

16. The biometric security method as claimed in claim 7 wherein said calculating a plurality of test keyboard metrics comprises calculating at least one metric selected from the set comprising an inter-key latency time, a hold time and a typing error measurement.

17. A biometric security system, comprising
a keyboard metric calculator to generate a plurality of test keyboard metrics from a received identity verification request;
an identity comparator to determine whether a typing pattern expressed in the received identity verification request substantially matches a typing pattern expressed in a one or more stored entries from a plurality of registered users, and in the event the typing pattern expressed in the received identity verification request substantially matches a plurality of the typing patterns expressed in the stored keyboard metrics, establish a closest matching registered user whose typing patterns, most closely match that of the received identity verification request;
a stress state comparator to compare the test keyboard metrics with a one or more stored keyboard metrics associated with a normally stressed state of the closest matching registered user;
an access controller to refuse access to a controlled resource in the event the typing pattern expressed in the received identity verification request does not substantially match any of the typing patterns expressed in the stored entries and in the event a match is found, to allow access to the controlled resource in the event the typing pattern expressed in the received identity verification request substantially matches that associated with a normally stressed state of the closest matching registered user.

18. An article, comprising a storage medium having stored thereon instructions that, in response to being executed by a processor of a computing platform, result in the computing platform performing the biometric security method as claimed in claim 1.

19. An automated teller machine comprising the biometric security system as claimed in claim 17.

20. A door entry system comprising the biometric security system as claimed in claim 17.

21. A portable wireless device comprising the biometric security system as claimed in claim 17.
